(19) United States
(12) Patent Application Publication
(10) Pub. No.: US 2014/0299106 A1
(43) Pub. Date: Oct. 9, 2014

(54) Autonomous Multi-Fuel Engine Using Gaseous Fuels

(71) Applicant: Compression Generation Services, LLC, Humble, TX (US)

(72) Inventor: John Pauk, Houston, TX (US)

(73) Assignee: Compression Generation Services, LLC, Humble, TX (US)

(21) Appl. No.: 14/245,131

(22) Filed: Apr. 4, 2014

Related U.S. Application Data
(60) Provisional application No. 61/808,921, filed on Apr. 5, 2013.

(51) Int. Cl. F02D 41/30

(52) U.S. Cl. CPC F02D 41/30
USPC 123/478

(57) ABSTRACT

An engine uses gaseous fuel from an intermittent fuel source and a backup fuel source. A fuel supply and control system includes intermittent and backup fuel supply lines, a sensor, a flow control device, and an engine controller. The intermittent and backup fuel supply lines deliver gaseous fuel from the intermittent and backup fuel sources to the engine. The sensor detects fluctuations in gaseous fuel availability within the intermittent fuel supply line and outputs a signal responsive to the fluctuations. The flow control device selectively enables gaseous fuel to the engine from either the intermittent fuel source or the backup fuel source. The engine controller receives the signal from the sensor and, responsive to the received signal, operates the flow control device to select between the intermittent fuel source and the backup fuel source as the supply of gaseous fuel to the engine.

### RELATED APPLICATIONS

This application claims the benefit of U.S. Provisional Application No. 61/808,921, filed Apr. 5, 2013.

### BACKGROUND

Engines are typically designed around a single fuel or blend of fuels. In the case of dual-fuel or bi-fuel engines using natural gas and diesel, the engines can operate on 100% diesel or substitute between 0 and 80% natural gas, but they are not capable of operating on 100% natural gas. In some cases, especially with natural gas engines, the fuel type or composition can be varied, but the engines often need to be shut down and recalibrated in order to operate on multiple fuels. With the exception of some new automotive bi-fuel engines, which can switch between fuel tanks based on an anticipated volume of fuel remaining in the tank, there are no engines in the mobile or stationary space that are designed to switch between fuels based on a transient unexpected change in fuel availability. This presents a particular challenge in certain applications, where it is critical to be able to switch between various fuels, including operation with a single fuel or blend of fuels, without any interruption in load. The reason for this is because load requirements of an application often vary independently of the fuel supply and therefore must be autonomously maintained regardless of availability of a particular fuel. Previous attempts at switching fuels during operation, have often resulted in a temporary loss in performance during the switch, which can have negative consequences, including being mission disabling.

Conventional methods of switching between fuels have several disadvantages. Engines need to be shut down and recalibrated to cope with a switch in fuel source. During a switch in fuel source, engines suffer a temporary loss in performance which can have negative consequences or be mission disabling. Employing larger engines or secondary backup power systems adds unnecessary cost and complexity. Engines which are able to switch between fuels do so by detecting the amount of fuel remaining in a fuel tank or fuel line by way of a pressure or level switch. This requires that the engine controller be in communication with the fuel source and the decision to operate or not operate is based on the status of a finite volume of fuel.

### DESCRIPTION OF THE DRAWINGS

FIG. 1 is a schematic diagram illustrating one embodiment of the fuel supply and control system of the present invention showing direct or port fuel injection.

FIG. 2 is a schematic diagram illustrating one embodiment of the fuel supply and control system of the present invention showing throttle body fuel injection instead of port injection or direct injection.

FIG. 3 is a schematic diagram illustrating one embodiment of the fuel supply and control system of the present invention, with one fuel control valve controlling both fuel lines.

FIG. 4 is a schematic diagram illustrating another embodiment of the fuel supply and control system of the present invention, including a vaporizer for liquefied gaseous fuel.

FIG. 5 is a flow chart illustrating one embodiment of the present invention method for supplying fuel to and controlling an engine for use with gaseous fuel from an intermittent fuel source and a backup fuel source.

### DETAILED DESCRIPTION

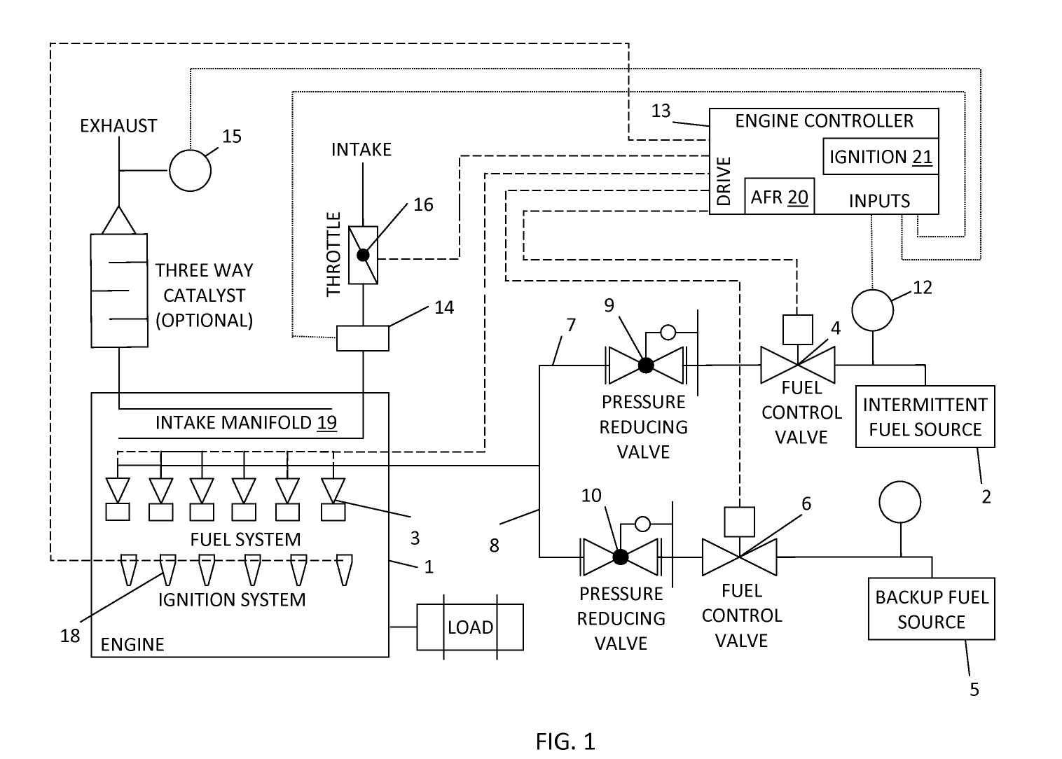

FIG. 1 illustrates one embodiment of the present invention fuel supply and control system for an engine 1 for use with gaseous fuel from an intermittent fuel source 2 and a backup fuel source 5. The type of gaseous fuel supplied by the backup fuel source 5 may be the same as or different than the type of gaseous fuel supplied by the intermittent fuel source 2. Although only one intermittent fuel source 2 and one backup fuel source 5 are illustrated, any number of intermittent fuel sources 2 and backup fuel sources 5 may be used and remain consistent with the present invention. Examples of intermittent 2 and backup sources 5 include tanks, pipelines, and wells.

It is advantageous to be able to seamlessly switch from one fuel to another without interruption in engine operation. Seamless switching, which minimizes changes in engine speed or load, is not only desired, but in some cases mission critical. The present invention discloses a system for switching between two gaseous fuels without interruption in the performance of an internal combustion engine 1 and without the need for sensors at the fuel source 2, 5.

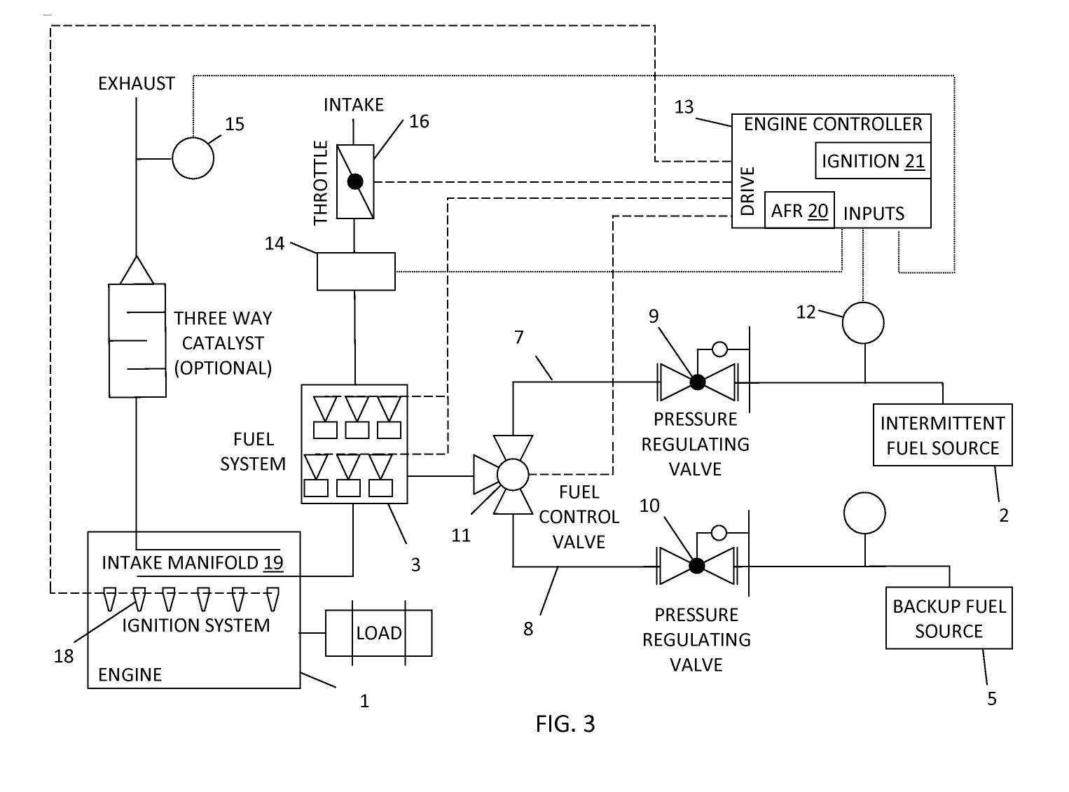

The engine 1 operates to create a demand for the gaseous fuel. In one embodiment, the fuel supply and control system includes intermittent 7 and backup 8 fuel supply lines, a sensor 12, at least one flow control device 4, 6, and 11 (FIG. 3), and an engine controller 13. The intermittent 7 and backup 8 fuel supply lines deliver gaseous fuel from the intermittent 2 and backup 5 fuel sources to the engine 1. The plumbing to the fuel system 3 is mechanically and fluidically configured to ensure that the appropriate amount of fuel is delivered according to the differences in the physical properties and combustion behavior of each fuel.

The sensor 12 is disposed in the intermittent fuel supply line 7. The sensor 12 detects fluctuations in gaseous fuel availability within the intermittent fuel supply line 12 and outputs a signal responsive to the fluctuations.

In one embodiment, the sensor 12 detects flow in the intermittent fuel supply line 7. The flow is representative of the fluctuations in gaseous fuel availability. In one embodiment, the sensor 12 is a volumetric flow sensor. In another embodiment, the sensor 12 is a mass flow sensor.

In one embodiment, the sensor 12 detects pressure in the intermittent fuel supply line 7. The pressure is representative of the fluctuations in gaseous fuel availability. In one embodiment, the sensor 12 is a pressure sensor.

Each flow control device 4, 6, and 11 is any device for controlling flow through a gaseous fuel supply line 7, 8. A valve is one example of a flow control device. The flow control devices 4, 6, and 11 are disposed in the intermittent fuel supply line 7 and the backup fuel supply line 8 between the engine 1, the intermittent fuel source 2, and the backup fuel source 5. The flow control devices 4, 6, and 11 selectively enable gaseous fuel to the engine 1 from either the intermittent fuel source 2 or the backup fuel source 5.

In one embodiment, the at least one flow control device 4, 6, and 11 includes a flow control device, or valve, 4 disposed in the intermittent fuel supply line 7 and a flow control device, or valve, 6 disposed in the backup fuel supply line 8. In one embodiment each flow control device 4, 6, is a two-way valve. FIG. 3 illustrates an embodiment of the fuel supply and control system having one three-way valve 11 disposed between the engine 1, the intermittent fuel source 2, and the backup fuel source 5.

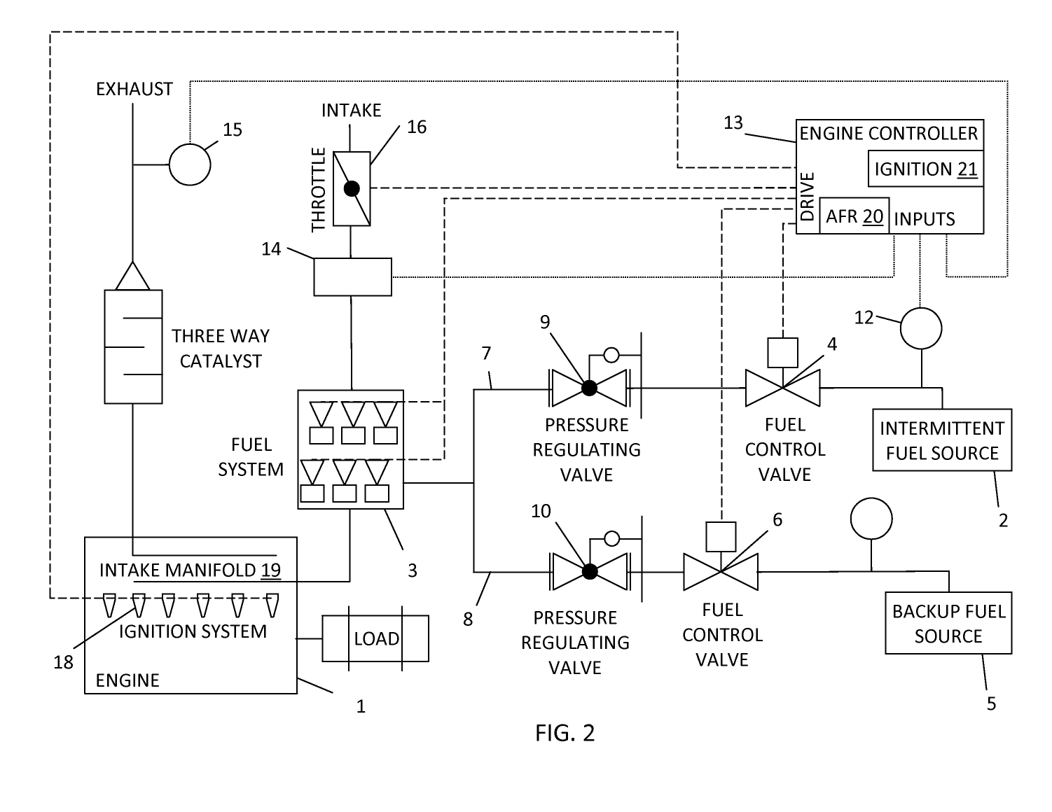

In one embodiment, a primary, intermittent, gaseous fuel source 2 is selectively connected to the engine's fuel system 3 (either port/direct fuel injectors, as shown in FIG. 1, or throttle body fuel admission valves, as shown in FIGS. 2-4) by way of a two-way switchable valve 4, and a backup gaseous fuel source 5, which may be selectively connected to the same engine 1 by way of an additional two-way switchable valve 6, such that with the exception of the switching event when some overlap may occur, only one fuel source 2, 5 is connected or substantially connected to the engine 1 at any given time. Prior to entering the fuel system, each fuel line 7, 8 is equipped with a pressure regulating valve 9, 10, which reduces fuel pressures to desired levels. The engine 1 is equipped with one or more fuel injection systems 3 for delivering multiple gaseous fuels to the engine 1.

Alternatively, the two two-way switchable valves 4, 6 are replaced with a single three-way valve 11 capable of selectively connecting the engine's fuel system 3 to either of two independent fuel sources 2, 5.

The engine controller 13 is in communication with the sensor 12 to receive the signal from the sensor 12. The engine controller 13, responsive to the received signal, operates the at least one flow control device 4, 6, and 11 to select between the intermittent fuel source 2 and the backup fuel source 5 as the supply of gaseous fuel to the engine 1. The intermittent fuel source 2 is selected when the availability of the gaseous fuel from the intermittent fuel source 2 is sufficient for the demand from the engine 1. The backup fuel source 5 is selected when the availability of the gaseous fuel from the intermittent fuel source 2 is insufficient for the demand from the engine 1.

In one embodiment, the engine controls are designed to switch between fuel sources 2, 5 by detection of a loss in fuel pressure or change in instantaneous flow rate by the sensor or switch 12 in the intermittent fuel line 7, at which time, the controller 13 will cut off fuel flow from the active fuel line 7, 8 by way of the switchable valve 4, 6, and 11 and open up fuel flow from one of the additional fuel lines 7, 8 by way of an additional switchable valve 4, 6, and 11.

The loss in pressure or change in flow detected in the intermittent fuel line 7 provides a signal to the engine controller 13 to adjust the desired air to fuel ratio (AFR), as determined by the various sensors including, a mass flow sensor 14 and an oxygen sensor 15. Fuel can be injected into the air intake upstream of the intake manifold, typically referred to as throttle body fuel injection (FIGS. 2-4). Alternative, fuel can be injected into the intake manifold, typically referred to as port injection (FIG. 1) immediately before the air charge is introduced into the engine cylinder by way of the opening of intake gas exchange valves. The fuel can also be injected directly into the combustion cylinder, typically referred to as direct fuel injection (FIG. 1).

The engine controller 13 is pre-programmed to automatically switch between fuels by switching between multiple engine operating tables, maps, or algorithms and accordingly adjusting parameters including, throttle 16 position, ignition 18 timing, mass flow rate, AFR, oxygen levels in exhaust stream, and AFR cycling values and frequency for purpose of catalyst control.

Alternatively, instead of separate operating tables for each fuel, the set points of a single operating table may be segregated for control of the AFR for each independent fuel. The AFR values are typically set according to engine speed and load. For example, an operating table may contain a plurality of set points, each defined by speed and load parameters, where speed values range from 0 to 1800 rpm and load values range between 0 and 100%. To segregate the set points for control of two independent fuels, only a fraction of the set points are used for the fuel from the intermittent fuel source 2 and the remaining set points can be used for the fuel from the backup fuel source 5. The control signals for engine speed and load may be manipulated as a function of fuel switching, such that the only the pertinent AFR set points in the table are referenced during operation with the fuel from the intermittent fuel source 2, and only the pertinent AFR set points in the table are referenced during operation with the fuel from the backup fuel source 5.

In one embodiment, the engine controller 13 includes an integrated or dedicated multi-set point AFR controller 20 for adjusting an AFR in the engine 1 responsive to the selection of fuel between the intermittent fuel source 2 and the backup fuel source 5. The set points of the AFR controller 20 are segregated and allocated between the intermittent fuel source 2 and the backup fuel source 5. In one embodiment, the AFR controller 20 includes set points governing the open-loop and adaptive AFR parameters. The set points in the AFR controller 20 may include open-loop and adaptive values for purposes of controlling the AFR under steady state, transient speed and load, and fuel switching conditions. The set points of the multi-set point controller 20 governing the open-loop and adaptive AFR parameters are adjusted according to the selection of fuel between the intermittent fuel source 2 and the backup fuel source 5.

Alternatively, instead of separate operating tables for each fuel, the set points of a single operating table may be segregated for control of ignition timing and duration for each independent fuel. The ignition timing and duration values are typically set according to engine speed and load. For example, an operating table may contain a plurality of set points, each defined by speed and load parameters, where speed values range from 0 to 1800 rpm and load values range between 0 and 100%. To segregate the set points for control of two independent fuels, only a fraction of the set points are used for setting the ignition timing and duration for the intermittent fuel source 2 and the remaining set points can be used for the backup fuel source 5. The control signals for engine speed and load may be manipulated as a function of fuel switching, such that the only the pertinent ignition set points in the table are referenced during operation with fuel from the intermittent fuel source 2, and only the pertinent ignition set points in the table are referenced during operation with fuel from the backup fuel source 5.

In one embodiment, the fuel supply and control system further includes an ignition system 18. The engine controller 13 includes an integrated or dedicated multi-set point ignition controller 21 for controlling the ignition timing and duration of the ignition system 18 responsive to the selection of fuel between the intermittent fuel source 2 and the backup fuel source 5. In one embodiment, the set points of the ignition controller 21 are segregated and allocated between the intermittent fuel source 2 and the backup fuel source 5. In one embodiment, the ignition controller 21 includes set points governing the ignition timing and duration parameters. The set points in the ignition controller 21 may include timing and duration values for purpose of controlling the ignition system 18 under steady state, transient speed and load, and fuel switching conditions. The set points of the multi-set point controller 21 governing the ignition timing and duration parameters are adjusted according to the selection of fuel between the intermittent fuel source 2 and the backup fuel source 5.

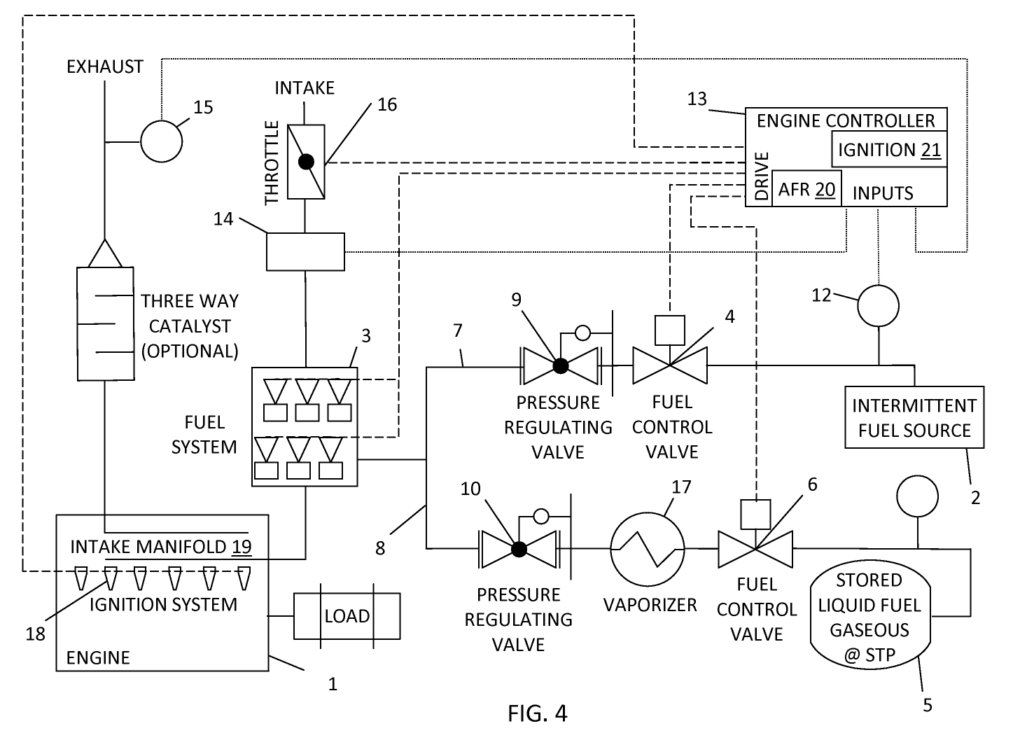

For clarity, gaseous fuel refers to any fuel that exists in gaseous form at STP (standard temperature and pressure). This includes fuels that when stored at temperature or pressure conditions other than standard, may exist in some other fluid phase, including solid or liquid phases. In such cases, the present invention may incorporate equipment, such as a vaporizer 17 (FIG. 4), to convert the fuel from sources 2, 5 into a gaseous phase prior to its introduction to the fuel system. FIG. 4 illustrates one embodiment of the fuel supply and control system having a vaporizer 17. The vaporizer 17 is disposed in the backup fuel supply line 8 between the backup fuel source 5 and the engine 1. Although not shown, a vaporizer 17 may be alternatively or additionally disposed in the intermittent fuel supply line 7 between the intermittent fuel source 2 and the engine 1.

In one embodiment, the engine 1 has an intake manifold 19. The pressure of the intake manifold 19 is controlled by the engine controller 13. The intake manifold pressure is controlled responsive to the selection of fuel between the intermittent fuel source 2 and the backup fuel source 5. The temperature of the intake manifold 19 may also controlled by the engine controller 13. The intake manifold temperature is controlled responsive to the selection of fuel between the intermittent fuel source 2 and the backup fuel source 5.

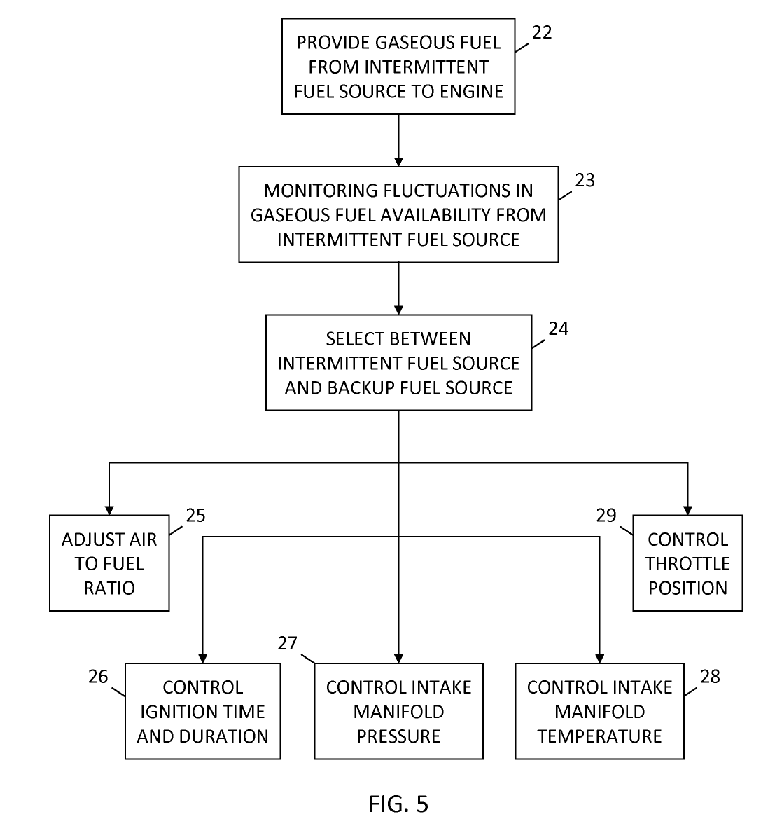

FIG. 5 is a flow chart representing steps of one embodiment method for use with gaseous fuel from an intermittent fuel source and a backup fuel source. Although the steps represented in FIG. 5 are presented in a specific order, the technology presented herein can be performed in any variation of this order. Furthermore, additional steps may be executed between the steps illustrated in FIG. 5.

Gaseous fuel is provided 22 from the intermittent fuel source 2 to the engine 1. Fluctuations in gaseous fuel availability from the intermittent fuel source 2 to the engine are monitored 23.

Responsive to the gaseous fuel availability, a selection 24 is made between the intermittent fuel source 2 and the backup fuel source 5 as the supply of gaseous fuel to the engine 1. The intermittent fuel source 2 is selected when the availability of the gaseous fuel from the intermittent fuel source 2 is sufficient for the demand from the engine 1. The backup fuel source 5 is selected when the availability of the gaseous fuel from the intermittent fuel source 2 is insufficient for the demand from the engine 1. Using this control logic, the ability of the engine 1 to operate is not only a function of fuel supply, but also of fuel consumption by the engine, such that while a higher fuel consuming engine, where the demand exceeds the supply, may not operate with the intermittent fuel source 2, a lower consuming engine, where the supply exceeds the demand, may operate with the intermittent fuel source with the same fuel availability. Similarly, while full load fuel consumption may be greater than the fuel supply, and operation is not possible, part load fuel consumption may be less than the fuel supply, such that operation is possible. This is in contrast to systems which sense the remaining fuel in a tank, which must shut down or switch to the backup fuel whenever the pressure or level in those tanks reaches a minimum threshold, regardless of the demand from the engine.

In one embodiment, monitoring 23 fluctuations in gaseous fuel availability includes monitoring 23 flow in the intermittent fuel supply line 7 between the intermittent fuel source 2 and the engine 1. The flow is representative of the fluctuations in gaseous fuel availability.

In one embodiment, monitoring 23 fluctuations in gaseous fuel availability includes monitoring 23 pressure in the intermittent fuel supply line 7 between the intermittent fuel source 2 and the engine 1. The pressure is representative of the fluctuations in gaseous fuel availability.

Several parameters may be controlled responsive to the selection of fuel between the intermittent fuel source 2 and the backup fuel source 5. In one embodiment, the AFR in the engine 1 is adjusted 25 responsive to the selection of fuel between the intermittent fuel source 2 and the backup fuel source 5. In one embodiment, the ignition timing and duration is controlled 26 responsive to the selection of fuel between the intermittent fuel source 2 and the backup fuel source 5. In one embodiment, the intake manifold pressure is controlled 27 responsive to the selection of fuel between the intermittent fuel source 2 and the backup fuel source 5. In one embodiment, the intake manifold temperature is controlled 28 responsive to the selection of fuel between the intermittent fuel source 2 and the backup fuel source 5. In one embodiment, the throttle position is controlled 29 responsive to the selection of fuel between the intermittent fuel source 2 and the backup fuel source 5.

One advantage of the present invention is that it allows a single engine 1 to operate on multiple fuels and autonomously switch between those fuels, especially when one fuel source 2 is intermittent, unexpectedly interrupted or unavailable, or when it is simply more desirable to operate on one fuel over another. The present invention is materially different from conventional multi-fuel engine systems which require electronic communication with at least one fuel source, usually a tank, in order to control the switching between sources 2, 5. In these conventional cases, the switching is anticipated and occurs in response to the volume, static pressure, or level of fuel remaining in the fuel source. The present invention differs from conventional systems in that it is controlled specifically by the dynamic pressure or change in mass flow of fuel passing through the engine's fuel system 3, such that no electronic communication is required with the actual fuel source 2, 5. Therefore, while conventional automotive systems are triggered by static conditions measured at the fuel source 2, 5, the present invention is designed around a transient response of fuel flow or pressure in an intermittent fuel line 7.

The transient condition occurs in the intermittent fuel line 7 as a result of the instantaneous difference in flow of fuel into the intermittent fuel line 7 from the intermittent fuel source 2 and the flow of fuel out of the intermittent fuel line 7 to the engine 1. If the flow of fuel coming into the intermittent fuel line 7 is greater than the fuel going out of the intermittent fuel line 7, then the pressure in the intermittent fuel line 7 will remain constant, or potentially even rise slightly, and no fuel switching need occur. If the fuel flow coming into the intermittent fuel line 7 is less than the fuel flow going out of the intermittent fuel line 7, the pressure in the intermittent fuel line 7 will drop, triggering a fuel switch to the backup fuel source 5. Using dynamic pressure or flow measurement ensures that any disruption of flow to the engine 1 in the intermittent fuel line 7 is quickly detected and appropriate fuel switching is autonomously initiated so as to ensure seamless uninterrupted operation of the engine 1.

The present invention allows an internal combustion engine 1 to switch from one gaseous fuel to another while maintaining the performance of the engine 1. Examples of performance criteria include the engine's power output, engine speed, or emission compliance.

The present invention entails the design and integration of mechanical, fluidic, and electronic control systems to ensure that engine performance is maintained during the switching operation from one fuel to another. The switching event ensures that proper air to fuel ratios and combustion characteristics are maintained within acceptable levels so as to minimize changes in engine power output, speed, and emissions.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A fuel supply and control system for an engine for use with gaseous fuel from an intermittent fuel source and a backup fuel source, the engine operating to create a demand for the gaseous fuel, the fuel supply and control system comprising:
an intermittent fuel supply line for delivering gaseous fuel from the intermittent fuel source to the engine;
a backup fuel supply line for delivering gaseous fuel from the backup fuel source to the engine;
a sensor disposed in the intermittent fuel supply line, wherein the sensor detects fluctuations in gaseous fuel availability within the intermittent fuel supply line and outputs a signal responsive to the fluctuations;
at least one flow control device disposed in the intermittent fuel supply line and the backup fuel supply line between the engine, the intermittent fuel source, and the backup fuel source for selectively enabling gaseous fuel to the engine from either the intermittent fuel source or the backup fuel source; and
an engine controller in communication with the sensor to receive the signal from the sensor and, responsive to the received signal, operate the at least one flow control device to select between the intermittent fuel source and the backup fuel source as the supply of gaseous fuel to the engine, wherein the intermittent fuel source is selected when the availability of the gaseous fuel from the intermittent fuel source is sufficient for the demand from the engine and the backup fuel source is selected when the availability of the gaseous fuel from the intermittent fuel source is insufficient for the demand from the engine.

2. The system of claim 1 wherein the sensor detects flow in the intermittent fuel supply line, the flow representative of the fluctuations in gaseous fuel availability.

3. The system of claim 1 wherein the sensor detects pressure in the intermittent fuel supply line, the pressure representative of the fluctuations in gaseous fuel availability.

4. The system of claim 1 wherein the sensor includes a pressure sensor.

5. The system of claim 1 wherein the sensor includes a volumetric flow sensor.

6. The system of claim 1 wherein the sensor includes a mass flow sensor.

7. The system of claim 1 wherein the at least one flow control device includes a flow control device disposed in the intermittent fuel supply line and a flow control device disposed in the backup fuel supply line.

8. The system of claim 1 further including a vaporizer disposed in the intermittent fuel supply line between the intermittent fuel source and the engine.

9. The system of claim 1 further including a vaporizer disposed in the backup fuel supply line between the backup fuel source and the engine.

10. The system of claim 1 wherein the engine controller includes a multi-set point air to fuel ratio controller for adjusting an air to fuel ratio in the engine responsive to the selection of fuel between the intermittent fuel source and the backup fuel source.

11. The system of claim 10 wherein the set points of the air to fuel ratio controller are segregated and allocated between the intermittent fuel source and the backup fuel source.

12. The system of claim 10 wherein the air to fuel ratio controller includes set points governing the open-loop and adaptive air to fuel ratio parameters, wherein the set points of the multi-set point controller governing the open-loop and adaptive air to fuel ratio parameters are adjusted according to the selection of fuel between the intermittent fuel source and the backup fuel source.

13. The system of claim 1 further including an ignition system and wherein the engine controller includes a multi-set point ignition controller for controlling the ignition timing and duration of the ignition system responsive to the selection of fuel between the intermittent fuel source and the backup fuel source.

14. The system of claim 13 wherein the set points of the ignition controller are segregated and allocated between the intermittent fuel source and the backup fuel source.

15. The system of claim 13 wherein the ignition controller includes set points governing the ignition timing and duration parameters, wherein the set points of the multi-set point controller governing the ignition timing and duration parameters are adjusted according to the selection of fuel between the intermittent fuel source and the backup fuel source.

16. The system of claim 1 further including an intake manifold having a pressure controlled by the engine controller and wherein the intake manifold pressure is controlled responsive to the selection of fuel between the intermittent fuel source and the backup fuel source.

17. The system of claim 1 further including an intake manifold having a temperature controlled by the engine controller and wherein the intake manifold temperature is controlled responsive to the selection of fuel between the intermittent fuel source and the backup fuel source.

18. The system of claim 1 further including a throttle having a position controlled by the engine controller and wherein the throttle position is controlled responsive to the selection of fuel between the intermittent fuel source and the backup fuel source.

19. A method for supplying fuel to and controlling an engine for use with gaseous fuel from an intermittent fuel source and a backup fuel source, the engine operating to create a demand for the gaseous fuel, the method comprising:
providing gaseous fuel from the intermittent fuel source to the engine;
monitoring fluctuations in gaseous fuel availability from the intermittent fuel source to the engine;
responsive to the gaseous fuel availability, selecting between the intermittent fuel source and a backup fuel source as the supply of gaseous fuel to the engine, wherein the intermittent fuel source is selected when the availability of the gaseous fuel from the intermittent fuel source is sufficient for the demand from the engine and the backup fuel source is selected when the availability of the gaseous fuel from the intermittent fuel source is insufficient for the demand from the engine.

20. The method of claim 19 wherein monitoring fluctuations in gaseous fuel availability includes monitoring flow in an intermittent fuel supply line between the intermittent fuel source and the engine, the flow representative of the fluctuations in gaseous fuel availability.

21. The method of claim 19 wherein monitoring fluctuations in gaseous fuel availability includes monitoring pressure in an intermittent fuel supply line between the intermittent fuel source and the engine, the pressure representative of the fluctuations in gaseous fuel availability.

22. The method of claim 19 further including adjusting an air to fuel ratio in the engine responsive to the selection of fuel between the intermittent fuel source and the backup fuel source.

23. The method of claim 19 further including controlling an ignition timing and duration of an ignition system responsive to the selection of fuel between the intermittent fuel source and the backup fuel source.

24. The method of claim 19 further including controlling an intake manifold pressure responsive to the selection of fuel between the intermittent fuel source and the backup fuel source.

25. The method of claim 19 further including controlling an intake manifold temperature responsive to the selection of fuel between the intermittent fuel source and the backup fuel source.

26. The method of claim 19 further including controlling a throttle position responsive to the selection of fuel between the intermittent fuel source and the backup fuel source.
